(19) United States
(12) Patent Application Publication
(10) Pub. No.: US 2010/0000431 A1
(43) Pub. Date: Jan. 7, 2010

(54) WEB OFFSET PRESS

(75) Inventors: Nobuyuki Kishigi, Hiroshima (JP); Yoshio Nitta, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/447,699

(22) PCT Filed: Nov. 30, 2007
(86) PCT No.: PCT/JP2007/073247

§ 371 Date: Apr. 29, 2009

(30) Foreign Application Priority Data
Nov. 30, 2006 (JP) 2006-324098

(51) Int. Cl. B41F 16/00

(52) U.S. Cl. 101/219

(57) ABSTRACT

It is an object to provide a web offset press in which the possibility of causing product quality problems can be prevented at least when a web is folded in two or is overlaid in two layers by a former board. It includes a former board; a folding processing device (F) that processes a half-width web that is folded in two or is overlaid in two layers by the former board into a signature; and a position-adjustment control device that adjusts the position of the former board in the widthwise direction of the half-width web so as to match the widthwise central position (WM) of the half-width web and the widthwise processing central position (MM) of the folding processing device (F); wherein the position-adjustment control unit stores a predetermined widthwise position of the former board according to the form of the half-width web and moves the former board to the predetermined widthwise position.

### TECHNICAL FIELD

The present invention relates to a web offset press.

### BACKGROUND ART

A web offset press prints on a web let out from a reel stand unit with a printing device, cuts it with a folding device into a predetermined size, folds them into predetermined signatures, and outputs them to the exterior.

A former board that folds the web into two is disposed upstream of this folding device, and a folding processing device that processes the web from the former board into a signature is disposed downstream.

The folding processing device includes, for example, nipping rollers that feed the web while applying tension thereto, a cutting cylinder that cuts the web in the width direction at intervals of a predetermined length, and a folding cylinder that folds the web cut by the cutting cylinder into two along the width direction while transporting the web by catching it with a pin device.

The folding processing device includes a chopper folder that folds the folded-in-two sheets output from the folding cylinder or the widthwise-cut webs from the former board into two along the transporting direction.

With such a folding processing device, various product quality problems occur if the widthwise central position of the web deviates laterally with respect to the widthwise central position thereof.

Specifically, for example, the nipping rollers that feed the web while applying tension thereto hold the web normally at both ends, which makes the force of the nipping rollers acting on both ends of the web uneven. This causes problems such as the web being wrinkled, partly folded, etc.

Moreover, for example, the catching position of the pin device on the cutting cylinder differs in the width direction, which causes problems in that more pinholes than expected are formed at a side edge of the web by the pin devices. Thus, the presence of pinholes at the edge of the web increases the risk of tearing the web starting from the pinholes.

Furthermore, with the chopper folder that folds the web into two along the transporting direction, the folding position is displaced.

To cope with these issues, as shown in Patent Document 1, for example, for webs with different widths, a device is proposed which moves the former board in the front-to-back direction to locate a vertex (folding-in-two position) of the former board at the center of the paper width.

This is predicated on the fact that paper widths differ and webs are longitudinally folded in two by the former board, and therefore, this device is still inadequate.

In particular, no consideration has been given to web offset presses for basically printing substantially fixed width paper, such as newspaper.

Newspaper includes what is called a tabloid format which is half the normal size (broadsheet format) (refer to Patent Document 2).

When printing the broadsheet format and the tabloid format with one web offset press, for the broadsheet format, a web is longitudinally folded in two with a former board and is fed to a folding processing device, and for the tabloid format, a web is slit along substantially the widthwise center of the web, and the slit webs are overlaid in two layers by the former board and are sent to the folding processing device.

Patent Document 1: Japanese Unexamined Patent Application, Publication No. 2002-210922

Patent Document 2: Japanese Translation of PCT International Application, Publication No. Hei 11-500700

### DISCLOSURE OF INVENTION

However, when the web is folded in two as in the broadsheet format, the web is folded at a vertex of a former board (at a folding-in-two position), so that the vertex position of the former board forms one end. On the other hand, for the tabloid format, the portion of the web corresponding to a vertex position of the former board is longitudinally cut, and therefore, because there is no resistance, the central portion of the web is divided before reaching the vertex of the former board, and the webs are fed to the downstream side.

Therefore, the widthwise central position of the web fed from the former board to the folding processing device results in a difference between the broadsheet format and the tabloid format; accordingly, when setting the widthwise processing central position of the folding processing device to one of them, the widthwise central position of a web fed from the former board and the widthwise processing central position of the folding processing device are displaced when printing the other, which causes the various problems described above.

Web offset presses for printing newspaper generally include former boards at two or more locations. For example, six former boards are sometimes provided. A plurality of webs that are processed individually by the plurality of former boards are fed in layers to a folding processing device. The webs processed by the individual former boards differ in the number of pages, the thickness of the paper, and between the broadsheet format and the tabloid format, and moreover, the state on the paper passing route from the former boards to the folding processing device sometimes differs (influenced by a twist due to rollers, etc.), which makes it extremely difficult to align the webs to be overlaid.

Such misalignment of the overlaid webs causes problems similar to those described above in the folding processing device, and thus, they are coped with by operating the printer once to adjust a running-paper transporting mechanism in the folding device.

However, this method allows adjustment only after actual printing. Moreover, the range of paper alignment is very limited because the adjustment is performed within a range not influencing the paper surface quality, which makes perfect alignment difficult. Furthermore, this takes much time for adjustment, which causes a large quantity of printing paper to be output as wasted paper during adjustment.

In view of the above problems, it is an object of the present invention to provide a web offset press in which the possibility of causing product quality problems can be prevented at least when a web is folded or overlaid in two layers with a former board.

Another object of the present invention is to provide a web offset press in which the possibility of causing product quality problems can be prevented when webs processed by a plurality of former boards are overlaid and folded.

To solve the above problems, the present invention employs the following solutions.

Specifically, an aspect of the present invention provides a web offset press including a former board; a folding processing device that processes a half-width web that is folded in two or is overlaid in two layers by the former board into a signature; and a position-adjustment control device that adjusts the position of the former board and/or the folding processing device in the widthwise direction of the half-width web so as to match the widthwise central position of the half-width web and the widthwise processing central position of the folding processing device; wherein the position-adjustment control device stores a predetermined widthwise position of the former board and/or the folding processing device according to the form of the half-width web and moves the former board and/or the folding processing device to the predetermined widthwise position.

According to this aspect, upon inputting whether the half-width web is to be folded in two or to be overlaid in two layers to the position-adjustment control device, the position-adjustment control device moves a former board and/or a folding processing device to a predetermined widthwise position on the basis of the predetermined widthwise position of the former board and/or the folding processing device according to the input form of the half-width web; therefore, the widthwise central position of the half-width web and the widthwise processing central position of the folding processing device can be matched in either case.

Since the widthwise central position of the half-width web and the widthwise processing central position of the folding processing device can always be matched in this way, the possibility of causing product quality problems in the signature can be prevented.

Since the position-adjustment control device can set the former board and/or the folding processing device in a predetermined widthwise position before printing, an operator's adjustment work before printing can be reduced, and the working time thereof can be decreased. This can optimize the fold quality of the signature from the beginning of printing and can reduce the amount of wasted paper.

For the predetermined widthwise position of the former board and/or the folding processing device, which is to be stored, for example, positions that are manually set at a trial operation may be used.

In the above aspect, it is preferable that the position-adjustment control device update the predetermined widthwise position using data on the widthwise positions of the former board and/or the folding processing device that are/is finely adjusted after initial setting.

In this way, since the position-adjustment control device updates the predetermined widthwise position using the data on the widthwise positions of the former board and/or the folding processing device that are/is finely adjusted after initial setting, the accuracy of initial setting can be improved gradually.

This can further reduce the operator's adjustment work before printing and can decrease the working time thereof. This can further optimize the fold quality of the signature from the beginning of printing and can further reduce the amount of wasted paper.

In the above aspect, it is preferable that the position-adjustment control device change the predetermined widthwise position in accordance with the number of folded webs processed by the former board.

When the number of overlaying layers of the web processed by the former board increases, the outer surface of the web is separated from the surface of the former board, so that the end position of the web adjacent to a vertex of the former board moves toward the vertex of the former board by a corresponding amount, which changes the widthwise central position of the half-width web.

According to the present invention, the position-adjustment control device changes the predetermined widthwise position in accordance with the number of overlaying layers of the web processed by the former board; therefore, the widthwise central position of the half-width web and the widthwise processing central position of the folding processing device can be matched with even higher accuracy.

In the above aspect, it is preferable that the position-adjustment control device change the predetermined widthwise position in accordance with the width of a web processed by the former board.

In this way, since the position-adjustment control device changes the predetermined widthwise position in accordance with the width of the web processed by the former board, the widthwise central position of the half-width web and the widthwise processing central position of the folding processing device can be matched even in a print job for a web having a different width.

In the above aspect, it is preferable that the position-adjustment control device change the predetermined widthwise position in accordance with the thickness of a web processed by the former board.

Furthermore, in the above aspect, it is preferable that the position-adjustment control device change the predetermined widthwise position in accordance with the circumferential speed of nipping rollers or a folding cylinder, which are the folding processing device.

This allows the widthwise central position of the half-width web and the widthwise processing central position of the folding processing device to be matched with even higher accuracy.

In the above aspect, a plurality of the former boards may be provided; and the position-adjustment control device may adjust the positions of the individual former boards in the widthwise direction of the half-width web.

Since this allows the widthwise central positions of the half-width webs and the widthwise processing central positions of the folding processing devices to be always matched at the individual former boards, the widthwise central positions WM of the half-width webs can be aligned at a fixed position.

Accordingly, this allows them to be aligned when introducing them in layers to the folding processing devices, thus preventing the possibility of causing product quality problems in the signature.

In the above aspect, a sensor unit for sensing the central position of the half-width web may be provided in a web running route along which the half-width web passes from the former board to the folding processing device, and the position-adjustment control device may move the former board and/or the folding processing device on the basis of the detection value from the sensor unit.

In this way, the position-adjustment control device is configured such that the sensor unit detects the central position of a half-width web passing therethrough and the former board and/or the folding processing device on the basis of a detection value thereof; therefore, even if the widthwise position of the half-width web moves between the former board and the sensor unit, it can be corrected. In other words, the former board and/or the folding processing device can be moved making allowance for the widthwise movement of the half-width web between the former board and the position of the sensor unit.

Accordingly, this allows the widthwise central position of the half-width web and the widthwise processing central position of the folding processing device to be further matched, thus reducing the possibility of causing product quality problems in the signature.

Furthermore, the accuracy of initial setting of the predetermined widthwise position can be improved gradually by updating the predetermined widthwise position using data on the widthwise position of the adjusted former board and/or the folding processing device.

It is preferable that the sensor unit be disposed close to the folding processing device.

According to the present invention, whether a half-width web is to be folded in two or to be overlaid in two layers is input to the position-adjustment control device, and the position-adjustment control device moves a former board and/or a folding processing device to a predetermined widthwise position on the basis of the predetermined widthwise position of the former board and/or the folding processing device according to the input form of the half-width web; therefore, the widthwise central position of the half-width web and the widthwise processing central position of the folding processing device can always be matched, thereby preventing the possibility of causing product quality problems in the signature.

Furthermore, the position-adjustment control device can set the former board and/or the folding processing device in a predetermined widthwise position before printing, so that the operator's adjustment work before printing can be reduced, and the working time thereof can be decreased. This can optimize the fold quality of the signature from the beginning of printing and can reduce the amount of wasted paper.

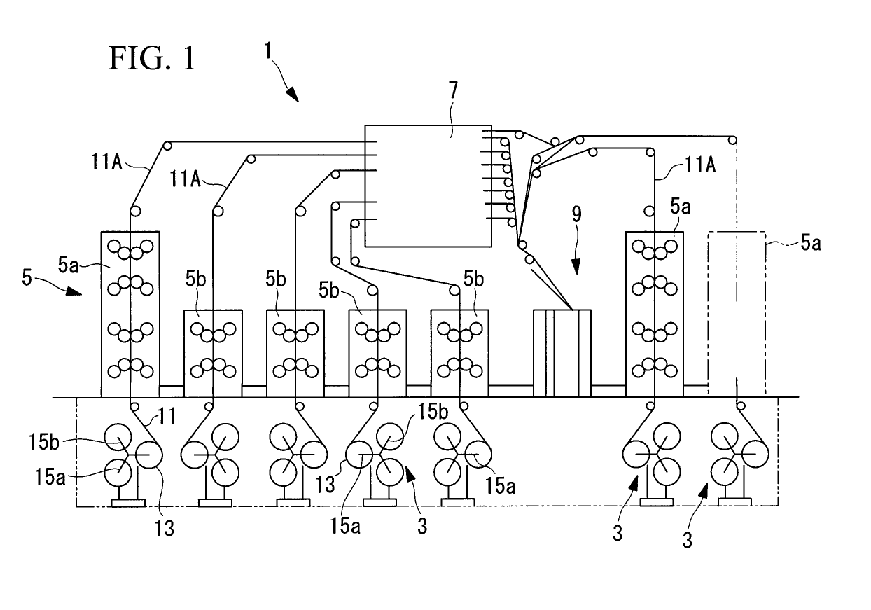

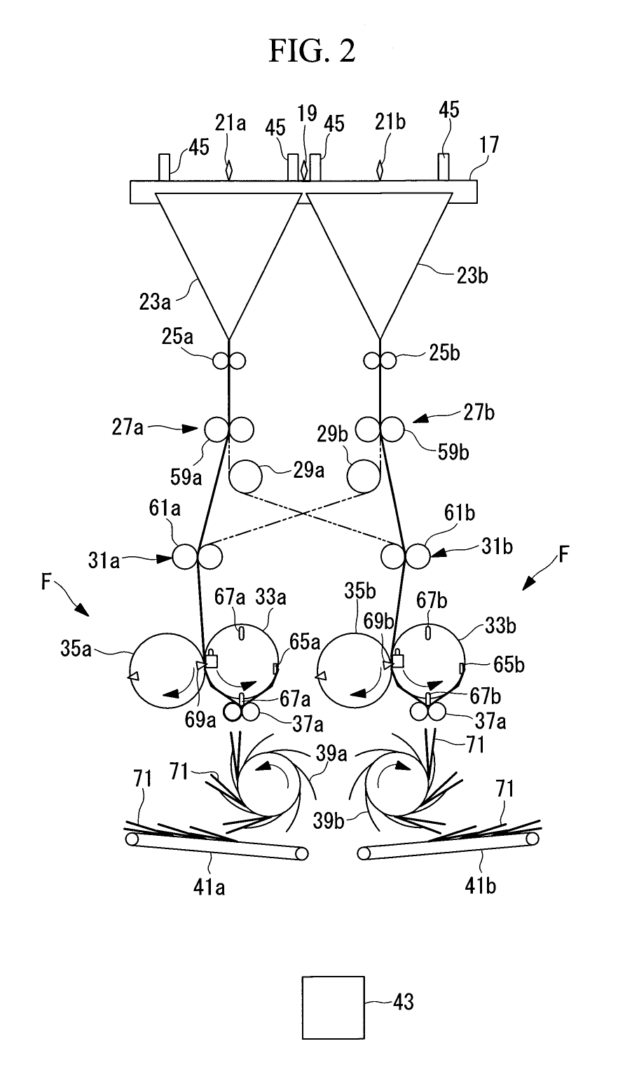

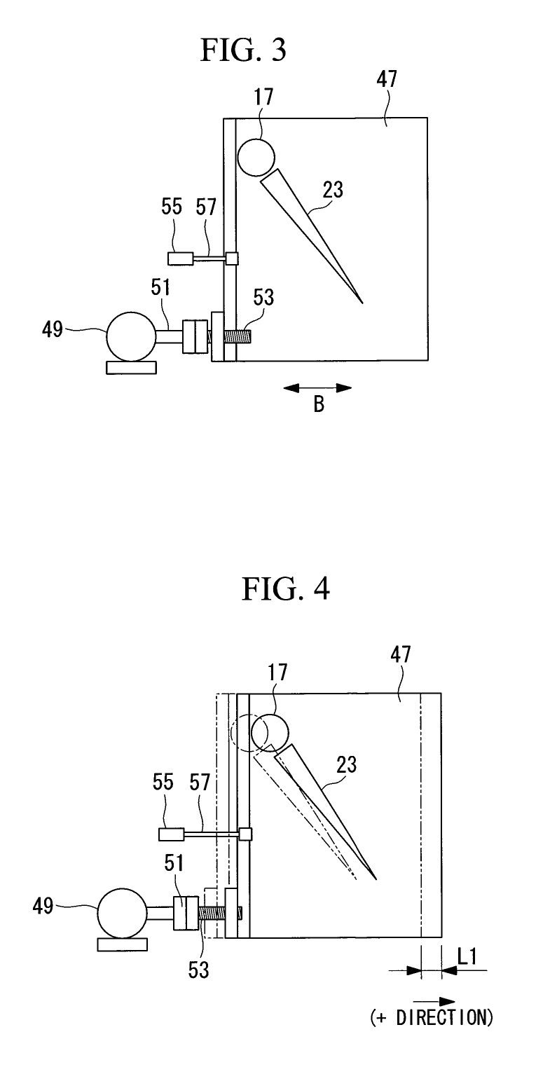

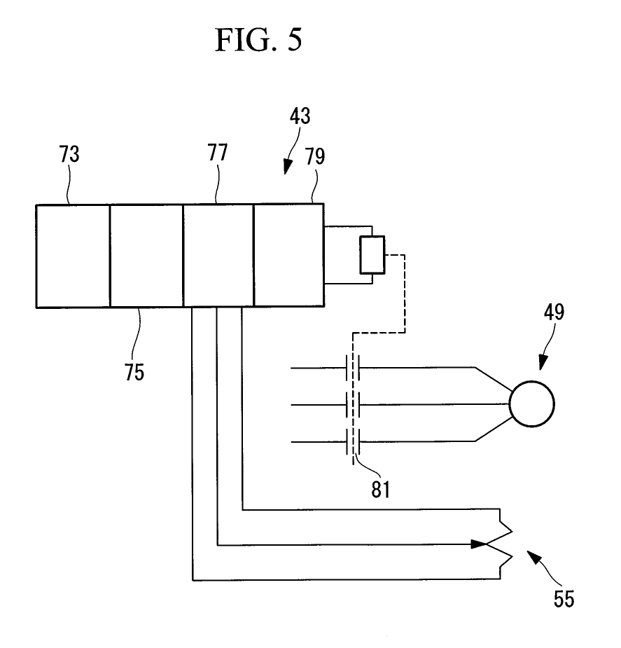

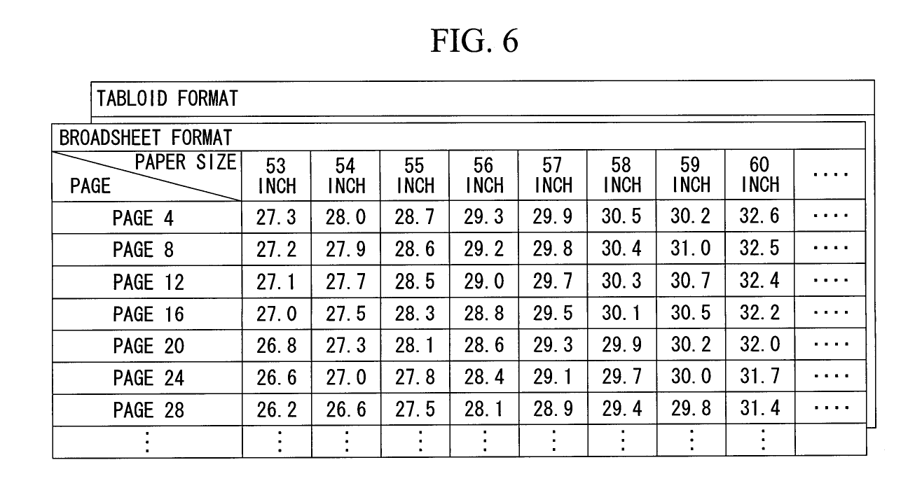

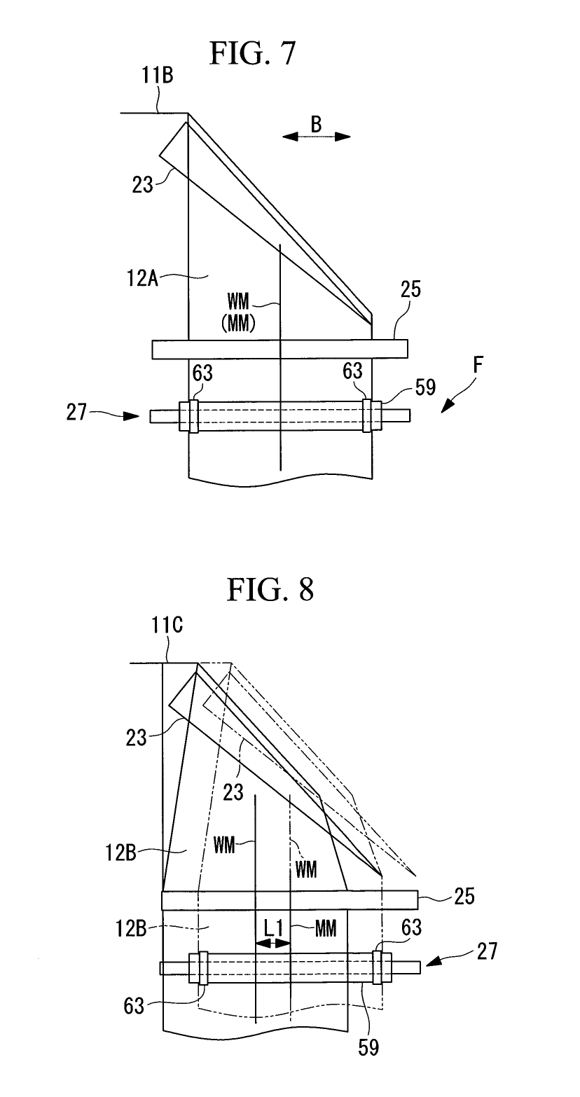

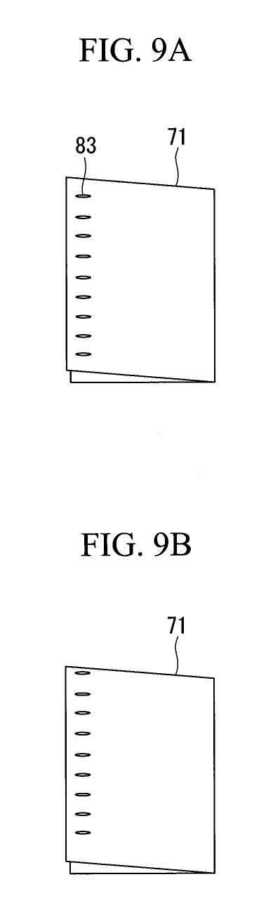

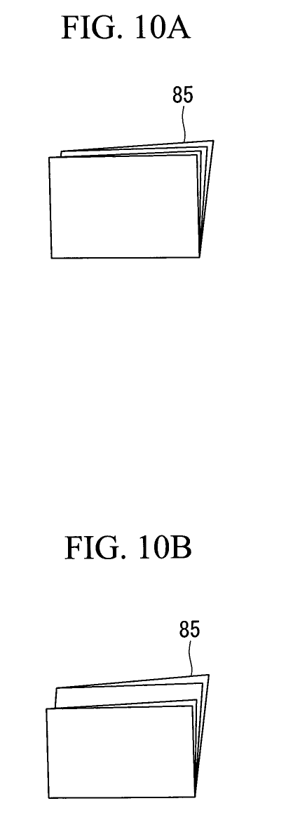

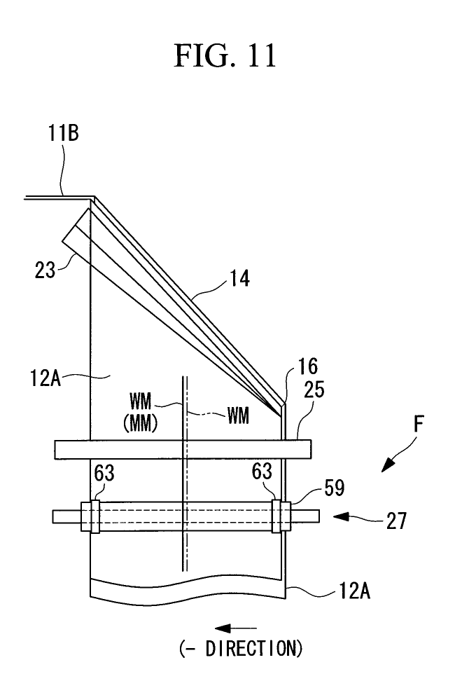

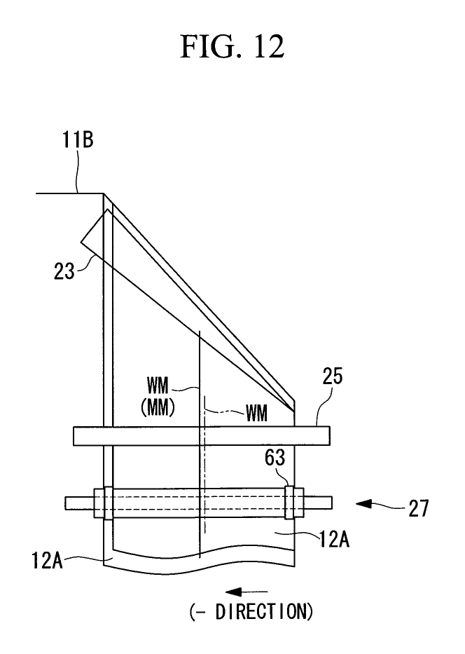

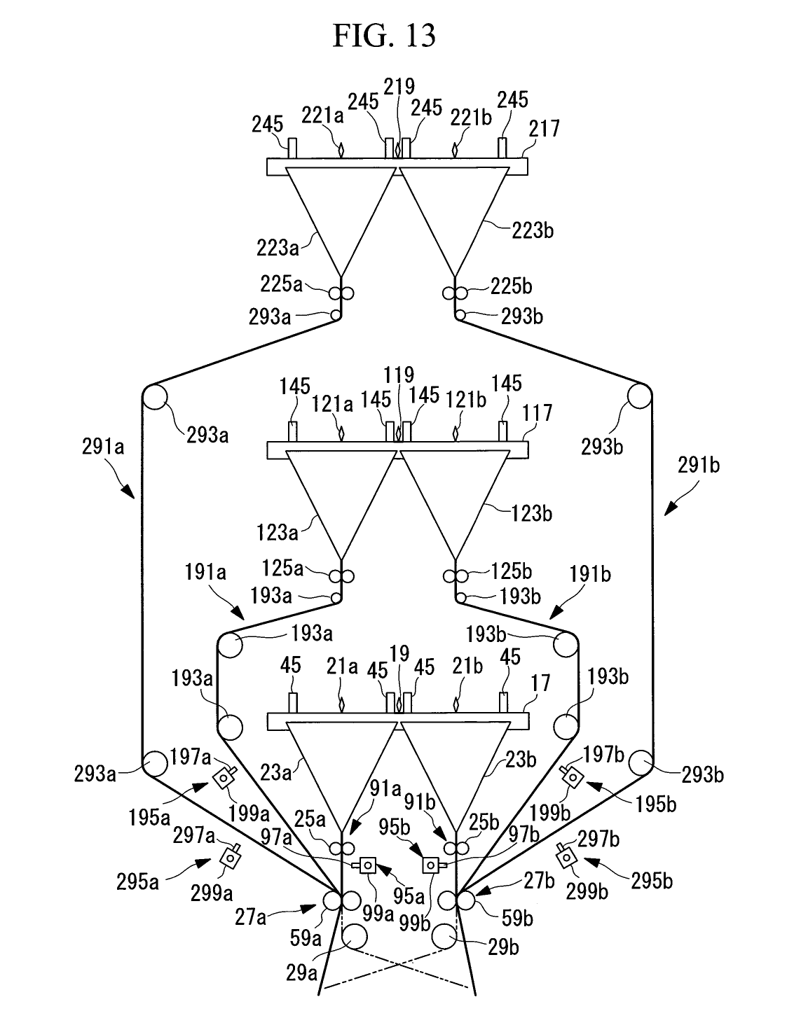

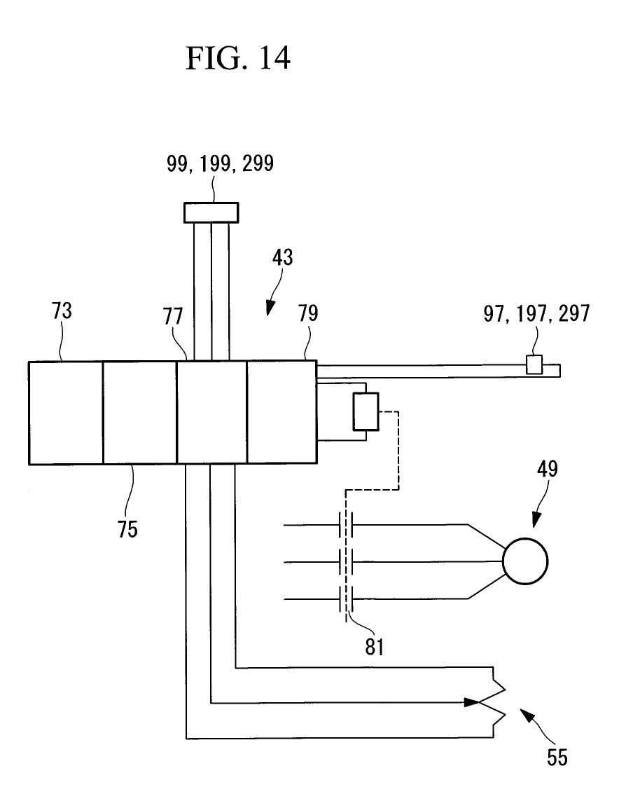

### BRIEF DESCRIPTION OF DRAWINGS

[FIG. 1] FIG. 1 is a front view showing the overall schematic configuration of a web offset press according to a first embodiment of the present invention.

[FIG. 2] FIG. 2 is a side view showing the overall schematic configuration of a folding device according to the first embodiment of the present invention.

[FIG. 3] FIG. 3 is a front view showing the upper part of the folding device according to the first embodiment of the present invention.

[FIG. 4] FIG. 4 is front view showing the upper part of the folding device according to the first embodiment of the present invention.

[FIG. 5] FIG. 5 is a block diagram showing a position-adjustment control unit according to the first embodiment of the present invention.

[FIG. 6] FIG. 6 is a conceptual diagram showing the content of positional data of a former board of the position-adjustment control unit according to the first embodiment of the present invention.

[FIG. 7] FIG. 7 is a front view showing the folding state at the upper part of the folding device according to the first embodiment of the present invention.

[FIG. 8] FIG. 8 is a front view showing the folding state at the upper part of the folding device according to the first embodiment of the present invention.

[FIG. 9A] FIG. 9A is a perspective view showing a normal signature according to the first embodiment of the present invention.

[FIG. 9B] FIG. 9B is a perspective view showing a defective signature according to the first embodiment of the present invention.

[FIG. 10A] FIG. 10A is a perspective view showing a chopper-folded normal signature.

[FIG. 10B] FIG. 10B is a perspective view showing a chopper-folded defective signature.

[FIG. 11] FIG. 11 is a front view showing the folding state at the upper part of the folding device according to the first embodiment of the present invention.

[FIG. 12] FIG. 12 is a front view showing the folding state at the upper part of the folding device according to the first embodiment of the present invention.

[FIG. 13] FIG. 13 is a side view showing the upper part of a folding device according to a second embodiment of the present invention.

[FIG. 14] FIG. 14 is a block diagram showing a position-adjustment control unit according to the second embodiment of the present invention.

### EXPLANATION OF REFERENCE SIGNS

1: web offset press
11A, B, C: web
12A, B: half-width web
23, 123, 223: former board
27: first nipping roller device
33: folding cylinder
43: position-adjustment control unit
71: signature
91, 191, 291: web running route
95, 195, 295: detection device
F: folding processing device
WM: widthwise central position
MM: widthwise processing central position

### BEST MODE FOR CARRYING OUT THE INVENTION

### First Embodiment

Hereinafter, a web offset press 1 for use in newspaper printing, according to a first embodiment of the present invention, will be described with reference to FIGS. 1 to 12.

The web offset press 1 is configured to output a broadsheet format and a tabloid format.

FIG. 1 is a front view showing the overall schematic configuration of the web offset press 1.

The web offset press 1 includes a plurality of reel stand units 3, a printing unit 5, a turn-bar array device 7, and a folding device 9.

The reel stand units 3 each include three pairs of arms 15 that each rotatably hold a paper roll 13 around which a web 11A is wound in a roll and a paper splicer.

When the web 11A is fed from the paper roll 13 mounted to an arm 15a located at a paper feeding position, the paper roll 13 on an arm 15b located at a paper splicing position stands by while preparing for paper splicing.

The web 11A has a width enabling printing of four pages (front-and-back eight page printing) in a broadsheet format.

When the remaining amount of the let-out web 11A on the paper roll 13 becomes small, it is spliced with the web 11 on the standby paper roll 13.

In this way, the web 11A is continuously let out from the reel stand unit 3 to the printing unit 5.

The printing unit 5 includes multicolor printing units 5a for performing duplex four-color printing and two-color printing units 5b for performing duplex two-color printing.

The multicolor printing units 5a and the two-color printing units 5b are shown by way of example; any suitable printing unit, such as a single-color printing unit for performing duplex single-color printing or a printing unit for performing one-sided four-color and multi-sided two-color printing, can be used.

The multicolor printing units 5a and the two-color printing units 5b individually perform predetermined printing on the webs 11 fed from the reel stand units 3 and feed them to the turn-bar array device 7.

The turn-bar array device 7 includes a large number of turn bars (not shown) and is configured to change the running routes of the webs 11A from the printing units 5a and 5b to change the overlaying order thereof.

The folding device 9 is configured to stack the plurality of webs 11A fed from the turn-bar array device 7 and longitudinally cut them, longitudinally fold them with a former board, or laterally cut or fold them, and output them as a desired signature.

The folding device 9 will be described next with reference to FIGS. 2 to 6.

FIG. 2 is a side view showing the overall schematic configuration of the folding device 9. FIGS. 3 and 4 are side views showing the upper part of the folding device 9. FIG. 5 is a schematic diagram showing a mechanism for moving former boards. FIG. 6 is a conceptual diagram showing the content of positional data of the former boards in a position-adjustment control unit.

The folding device 9 includes a drag roller 17, a center slitter 19, tabloid slitters 21, former boards 23, lead-in rollers 25, first nipping roller devices 27, guide rollers 29, second nipping roller devices 31, folding cylinders 33, cutting cylinders 35, folding rollers 37, impellers 39, delivery conveyors 41, and a position-adjustment control unit (position-adjustment control device) 43.

The components of the folding device 9 except for the drag roller 17, the center slitter 19, and the position-adjustment control unit 43 are disposed in parallel on the right and left, in two sets, as shown in FIG. 2.

The suffixes “a” and “b” attached at the end of the reference numerals in the drawings are for discriminating the two sets from each other; “a” indicates parts or members on the left in FIG. 2, and “b” indicates those on the right.

In the specification hereinafter, when distinguishing the left and right, “a” and “b” are attached, whereas when not distinguishing them, parts or members are denoted only by reference numerals with “a” and “b” omitted.

As shown in FIGS. 3 and 4, the drag roller 17 and the former boards 23 are mounted to a pair of right and left moving frames 47.

The drag roller 17 has a length longer than the sum of the widths of the former boards 23a and 23b and is rotationally supported by the moving frames 47 and 47. The drag roller 17 is configured to be rotationally driven by a driving mechanism (not shown).

Paper retaining rollers 45 are shaped like a disc formed of hard synthetic rubber or plastic and are configured to be brought into or out of contact with the drag roller 17 by a driving mechanism (not shown) and can be freely rotated (see FIG. 2).

The paper retaining rollers 45 push the plurality of webs 11A, in layers, fed from the turn-bar array device 7 against the drag roller 17.

The plurality of paper retaining rollers 45 are individually disposed in the width direction of the drag roller 17 in correspondence with portions of the web 11A which are not generally printed.

A paper drawing surface on which diamond powder is fixed by, for example, nickel electrodeposition, is formed at positions on the drag roller 17 corresponding to the paper retaining rollers 45 to increase the frictional coefficient thereof.

The moving frames 47 and 47 are mounted so as to move substantially horizontally in the direction perpendicular to the axis of the drag roller 17. That is, the moving frames 47 and 47 are configured to be able to move along the widthwise directions B of the webs fed from the former boards 23.

An electric motor 49 is mounted at fixed position.

An output shaft 51 of the electric motor 49 extends substantially horizontally in the direction perpendicular to the axis of the drag roller 17.

A threaded shaft 53 screwed in the moving frame 47 is coupled with the output shaft 51 so as to extend from the output shaft 51.

When the electric motor 49 is rotationally driven, the threaded shaft 53 rotates, so that the moving frame 47 is moved along the widthwise direction B.

A potentiometer 55 is mounted at fixed position.

The distal end of actuating shaft 57 of the potentiometer 55 is fixed to the moving frame 47 and moves together with the moving frame 47.

The potentiometer 55 recognizes the movement of the operating shaft 57 as changes in electrical resistance to allow the positions of the moving frames 47 to be determined.

The center slitter 19 is a disc-shaped edged tool, which is disposed substantially at the center in the axial direction of the drag roller 17.

The center slitter 19 is mounted so as to be rotationally driven by a driving mechanism (not shown) and come into and out of contact with the drag roller 17.

The center slitter 19 longitudinally slits the substantially central portion of the web 11A, that is, divides it into two, i.e., into webs 11B (to be led to the former boards 23) half the width of the web 11A (a two-page width in broadsheet format, front and back four-page printing).

The tabloid slitters 21 are disc-shaped edged tools, which are disposed substantially at the centers of the former boards 23a and 23b in the axial direction of the drag roller 17.

The tabloid slitters 21 are mounted so as to be rotationally driven by a driving mechanism (not shown) and come into and out of contact with the drag roller 17.

The tabloid slitters 21 longitudinally slit the substantially central portions of the webs 11B, that is, divide each web 11B into two, i.e., a web 11C half the width of the web 11B (a one-page width in broadsheet format, front and back two-page printing).

The former boards 23 are former boards that are disposed such that one side thereof is disposed along the drag roller 17, and the vertex opposing that side is located diagonally below.

The former boards 23 fold the passing webs 11B into two to form half-width webs (folded-in-two half-width webs) 12A. The former boards 23 also overlay a pair of passing webs 11C one on another to form a half-width web (double-layered half-width webs) 12B.

The lead-in rollers 25 are composed of a pair of rollers disposed with a space therebetween, which guide the half-width webs 12A and 12B downward from the former boards 23.

The first nipping roller devices 27 and the second nipping roller devices 31 are composed of a pair of first nipping rollers 59 and a pair of second nipping rollers 61, respectively, which are provided so as to come into and out of contact with each other.

The first nipping rollers 59 and the second nipping rollers 61 are configured to be rotationally driven individually by driving mechanisms (not shown).

Substantially cylindrical nipping collars 63 are mounted in the vicinity of both ends of each of the first nipping rollers 59 and the second nipping rollers 61 so as to protrude therefrom.

The guide rollers 29 guide the half-width webs 12A and 12B on one side to the second nipping roller device 31 on the other side.

The folding cylinders 33 have a pair of pin devices 65 for holding the webs 11 and a pair of folding blades 67 on the circumferential surface thereof.

The cutting cylinders 35 include a pair of cutters 59, at the circumferential surface thereof, extending in the width direction.

The folding rollers 37 are composed of a pair of rollers that press signatures from the cutting cylinders 35.

The impellers 39 have a plurality of blades protruding around the circumferential surface thereof at substantially regular intervals and receive signatures 71 from the folding rollers 37 and transfer them to the delivery conveyors 41.

The first nipping roller devices 27, the second nipping roller devices 31, the folding cylinders 33, the cutting cylinders 35, and the folding rollers 37 constitute folding processing devices F of the present invention.

The position-adjustment control unit 43 includes a memory board 73, a PLC CPU 75, an analog input board 77, and an I/O output board 79.

The memory board 73 stores information necessary for position adjustment control. As schematically shown in FIG. 6, it stores positional data (in mm) of the former boards 23 in the widthwise direction B, when the paper size, i.e., the width of the web 11A, and the number of web pages, i.e., the number of the webs 11B stacked (four pages correspond to one sheet), are used as parameters, for the two types, that is, the broadsheet format and the tabloid format. The positional data indicates distances from an origin (not shown); the + direction is to the right and the − direction is to the left in FIG. 4.

This memory can be updated.

The analog input board 77 acquires voltage values, which indicate the positional data of the former boards 23, from the potentiometers 55.

The PLC CPU 75 receives information on whether broadsheet-format printing or tabloid-format printing is to be performed, information on the width of the web 11A, and information on the number of pages and selects the widthwise positions (predetermined widthwise positions) of the former boards 23 on the basis thereof using the information stored in the memory board 73. It calculates the moving directions and moving distances of the former boards 23 on the basis of the difference between the selected widthwise positions B of the former boards 23 and the present positions of the former boards 23 input from the potentiometers 55 via the analog input board 77. The electric motor 49 is rotationally driven on the basis of the calculated moving directions and moving distances of the former boards 23 via the I/O output board 79.

The I/O output board 79 controls the opening and closing of contactors 81 in accordance with an instruction from the PLC CPU 75 to operate the electric motor 49 in a predetermined way.

The printing operation of the thus-configured web offset press 1 according to this embodiment will be described also with reference to FIGS. 7 to 12.

For example, when printing four-page newspaper in a broadsheet format, information about broadsheet format printing, four-page printing, and a 60-inch paper size (1,524 mm paper width) is transmitted from an operation control unit (not shown) to the position-adjustment control unit 43.

In the position-adjustment control unit 43, the PLC CPU 75 selects the widthwise positions B of the former boards 23 from the information stored in the memory board 73 on the basis of this information and calculates the moving directions and moving distances of the former boards 23 on the basis of the difference between the selected widthwise positions B of the former boards 23 and the present positions of the former boards 23 input via the analog input board 77.

The PLC CPU 75 rotationally drives the electric motor 49 via the I/O output board 79 on the basis of the calculated moving directions and moving distances of the former boards 23 to move the former boards 23 to the predetermined widthwise position shown in FIG. 7.

At this position, widthwise central positions WM of the half-width webs 12A folded in two by the former boards 23 and widthwise processing central positions MM of the folding processing devices F match.

In this way, the position-adjustment control unit 43 can set the former boards 23 at predetermined widthwise positions before printing, which can decrease the operator's adjustment work before printing, thereby reducing the working time thereof. This can optimize the fold quality of the signatures 71 from the beginning of printing and can reduce the amount of wasted paper.

In this case, printing is performed with one printing unit because it is four-page printing. Accordingly, one printing unit to be used is selected from the plurality of multicolor printing units 5a or two-color printing units 5b.

The web 11A let out from the paper rolls 13 held by the arms 15 of the reel stand unit 3 corresponding to the selected multicolor printing unit 5a or two-color printing unit 5b is fed to the selected multicolor printing unit 5a or two-color printing unit 5b and is fed to the folding device 9 through the turn-bar array device 7.

When the paper passing of the web 11A is thus completed, various adjustments, such as registration adjustment and cutting-position adjustment, are performed at a speed lower than printing speed.

At that time, if a problem occurs in the signatures 71, the positions of the former boards 23 are finely adjusted by hand so as to eliminate it.

The finely adjusted positions of the former boards 23 are sent to the position-adjustment control unit 43 at an appropriate time after a print job has started. The positional data of the former boards 23 corresponding to the conditions, which data is stored in the memory board 73, is replaced with this positional data that is sent.

In this way, the position-adjustment control unit 43 updates the predetermined widthwise positions using the data on the widthwise positions of the former boards, finely adjusted after initial setting, which can gradually improve the accuracy of the initial setting.

This can further decrease the operator's adjustment work before printing, thereby reducing the working time thereof. This can further optimize the fold quality of the signatures 71 from the beginning of printing and can further reduce the amount of wasted paper.

Upon completion of this adjustment work, the web offset press 1 is increased in speed to printing speed and enters a print job.

The web 11A that is subjected to duplex printing by the multicolor printing unit 5a or the two-color printing unit 5b enters the folding device 9 through the turn-bar array device 7. The web 11A that has entered the folding device 9 is transported downstream by the drag roller 17 and the paper retaining rollers 45 at a speed slightly higher than the speed of the web 11A that passes through the turn-bar array device 7.

At that time, the tabloid slitters 21 are separated from the drag roller 17, and the center slitter 19 engages with the drag roller 17, so that the web 11A is slit at the center by the center slitter 19. The slit webs 11B are introduced individually to the former boards 23a and 23b.

The webs 11B introduced to the former boards 23 are longitudinally folded in two into the half-width webs 12A. The half-width webs 12A are guided by the lead-in rollers 25 and are introduced to the first nipping roller devices 27.

In the first nipping roller devices 27, the half-width webs 12A are fed out downstream, with non-printed portions at both ends thereof being nipped by the pair of nipping collars 63.

At that time, the nipping collars 63 are rotated at a circumferential speed slightly higher than the introduced half-width webs 12A, so that the upstream-side half-width webs 12A are subjected to tension and are fed out downstream.

The half-width webs 12A fed out from the first nipping roller devices 27 are fed downstream at an even faster circumferential speed by the second nipping roller devices 31.

At that time, they can be fed to the adjacent second nipping roller devices 31 via the guide rollers 29, depending on the configuration of the newspaper.

Since the widthwise central positions WM of the half-width webs 12A and the widthwise processing central positions MM of the folding processing devices F match at that time, both ends of the half-width webs 12A fed out through the first nipping roller devices 27 and the second nipping roller devices 31 engage with the nipping collars 63 over a substantially equal widthwise length.

This allows both ends of the half-width webs 12A to be drawn by substantially equal forces, thus preventing the possibility of causing product quality problems such as wrinkling or paper folding.

The half-width webs 12A fed from the second nipping roller devices 31 are introduced between the folding cylinders 33 and the cutting cylinders 35 that rotate in an opposite direction from each other.

The folding cylinders 33 rotate the half-width webs 12A while holding them by sticking the pins of the pin devices 65 into the distal ends of the half-width webs 12A.

The downstream portions of the half-width webs 12A transported due to the rotation of the folding cylinders 33 are crosscut by cutters 69 of the cutting cylinders 35.

The pin devices 65 on the folding cylinders 33 stop holding the half-width webs 12A, and the folding blades 67 project substantially at the crosscut timing.

The cut half-width webs 12A are laterally folded by the folding blades 67 that project above the folding rollers 37 to form the signatures 71.

The signatures 71 from the cutting cylinders 35 are pressed by the folding rollers 37 so that the folds thereof become sharp and drop in between the blades of the impellers 39.

They are dropped onto the lower delivery conveyors 41 one by one using the rotation of the impellers 39 and are transported outside the device by the delivery conveyors 41.

Since the widthwise central positions WM of the half-width webs 12A and the widthwise processing central positions MM of the folding processing devices F match at that time, pinholes 83 formed by the pin devices 65 on the folding cylinders 33 are distributed around the central portion and are not provided at one side, as shown in FIG. 9(a).

For example, as shown in FIG. 9(b), when the distribution of the pinholes 83 is one-sided, there is a high risk of tearing the end of the signature 71 with the pinholes 83 at the end acting as starting points.

In this embodiment, the distribution of the pinholes 83 is not one-sided, as described above, thus preventing the possibility of causing product quality problems such as tearing the end of the signature 71.

One type of web offset press 1 is configured to fold the signatures 71 folded by the folding cylinders 33 in two along the transporting direction of the signatures 71 with chopper folders (folding processing devices F) to form signatures 85 (see FIG. 10).

In this case, the folding position deviates, causing the signatures 85 to be formed with long and short folded pieces, as shown in FIG. 10(b), unless the widthwise central positions WM of the half-width webs 12A and the widthwise processing central positions MM of the folding processing devices F match.

Since this embodiment is configured to match the widthwise central positions WM of the half-width webs 12A with the widthwise processing central positions MM of the folding processing devices F, the possibility of causing product quality problems, such as forming long and short folded pieces of the signatures 85, can be prevented.

Next, for example, a case in which eight-page newspaper is printed in a tabloid format (corresponding to four pages in a broadsheet format) will be described.

For the tabloid format, as will be described later, the portions of the webs 11B corresponding to vertices of the former boards 23 have been longitudinally cut, which causes no resistance, so that the central portions that are the cut portions of the webs 11B are divided before reaching the vertices of the former boards 23, and the webs are fed downstream, as shown in FIG. 8.

Assuming that the positions of the former boards 23 are the same as in the above-described broadsheet format, the widthwise central positions WM of the half-width webs 12B and the widthwise processing central positions MM of the folding processing devices F deviate by a distance L.

In this case, information about tabloid-format printing, eight-page printing, and a 60-inch paper size (1,524 mm paper width) is transmitted from an operation control unit (not shown) to the position-adjustment control unit 43.

In the position-adjustment control unit 43, the PLC CPU 75 selects the widthwise positions B of the former boards 23 from the information stored in the memory board 73 on the basis of this information.

The PLC CPU 75 calculates the moving directions and moving distances of the former boards 23 on the basis of the difference between the selected widthwise positions B of the former boards 23 and the present positions of the former boards 23 input via the analog input board 77.

The PLC CPU 75 rotationally drives the electric motor 49 via the I/O output board 79 on the basis of the calculated moving directions and moving distances of the former boards 23.

When the electric motor 49 is rotationally driven, the threaded shaft 53 rotate, so that the moving frames 47 that are screwed on the threaded shaft 53 are moved, in this case, in the + direction by the distance L (see FIG. 4).

This makes the widthwise central positions WM of the half-width webs 12B from the former boards 23 and the widthwise processing central positions MM of the folding processing devices F match.

In this state, the web offset press 1 is operated as in the above, the above-described adjusting operations are performed in midstream, and the web offset press 1 is increased to printing speed and enters a print job.

The web 11A that is subjected to duplex printing by the multicolor printing unit 5a or the two-color printing unit 5b enters the folding device 9 through the turn-bar array device 7. The web 11A that has entered the folding device 9 is transported downstream by the drag roller 17 and the paper retaining rollers 45 at a speed slightly higher than the speed of the web 11A that passes through the turn-bar array device 7.

At that time, the tabloid slitters 21 and the center slitter 19 are in close engagement with the drag roller 17, so that the web 11A is longitudinally slit at the substantially central portion by the center slitter 19, and is then longitudinally slit at the substantially central portion into the webs 11C. That is, it is slit into substantially four equal parts. The slit webs 11C are introduced individually to the former boards 23a and 23b.

The webs 11C introduced to the former boards 23 are separated by the former boards 23, and they are then overlaid to form the half-width webs 12B.

The half-width webs 12B are processed by the folding processing devices F as in the above into the signatures 71 and are transported outside the device by the delivery conveyors.

In this way, the position-adjustment control unit 43 moves the former boards 23 to predetermined widthwise central positions WM depending on the printing mode, namely, a broadsheet format or a tabloid format; therefore, the widthwise central positions WM of the half-width webs 12A and 12B can be matched to the widthwise processing central positions MM of the folding processing devices F.

In this way, the widthwise central positions WM of the half-width webs 12A and 12B and the widthwise processing central positions MM of the folding processing devices F can always be matched, thus reducing the possibility of causing product quality problems in the signatures 71.

Next, for example, a case in which 28-page newspaper in a broadsheet format is printed will be described with reference to FIG. 11.

In this case, seven, i.e., all the printing units are used.

The webs 11A that are subjected to duplex printing by the individual printing units are changed in running route by the turn-bar array device 7, are adjusted in the overlaying order to match the page configuration of the newspaper, and are overlaid one on another between the drag roller 17 and the paper retaining rollers 45.

Since the webs 11B, which are thereafter slit by the center slitter 19 and are introduced to the former boards 23, are overlaid in seven layers, the position of the outer surface 14 thereof is separated from the surface of the former boards 23, as shown in FIG. 11, as compared with one sheet shown in FIG. 7.

This causes them to protrude also in the + direction at the positions passing the vertices of the former boards 23 because the former boards 23 are inclined. Therefore, the width of the half-width webs 12A increases in the + direction by a correspond amount.

Thus, the widthwise central positions WM of the half-width webs 12A move in the + direction (to the right in FIG. 11), as indicated by the chain double-dashed line, as compared with the state in FIG. 7; therefore they deviate from the widthwise processing central positions MM of the folding processing devices F.

In this case, information about broadsheet format printing, 28-page printing, and a 60-inch paper size (1,524 mm paper width) is transmitted from an operation control unit (not shown) to the position-adjustment control unit 43.

In the position-adjustment control unit 43, the PLC CPU 75 selects the widthwise positions B of the former boards 23 from the information stored in the memory board 73 on the basis of this information.

The PLC CPU 75 calculates the moving directions and moving distances of the former boards 23 on the basis of the difference between the selected widthwise positions B of the former boards 23 and the present positions of the former boards 23 input via the analog input board 77.

The PLC CPU 75 rotationally drives the electric motor 49 via the I/O output board 79 on the basis of the calculated moving directions and moving distances of the former boards 23 to move the former boards 23, in this case, in the − direction.

This makes the widthwise central positions WM of the half-width webs 12A from the former boards 23 and the widthwise processing central positions MM of the folding processing devices F match.

Since the other operations are the same as those described with reference to FIG. 7, duplicated descriptions thereof will be omitted here.

In this way, the position-adjustment control unit 43 changes the predetermined widthwise central positions WM in accordance with the number of overlaying layers of the webs 11B processed by the former boards 23, so that the widthwise central positions WM of the half-width webs 12A and 12B and the widthwise processing central positions MM of the folding processing devices F can be matched with even higher accuracy.

For example, a case in which four-page newspaper is printed in a broadsheet format using the webs 11A of 56 inch (1,422 mm) in paper width will be described with reference to FIG. 12.

In this case, the webs 11B introduced to the former boards 23 are smaller in width than those shown in FIG. 7.

Since the central portions of the webs 11B pass the vertices of the former boards 23, the + direction side positions (the right in FIG. 12) of the half-width webs 12A do not change, but the − direction side positions (the left in FIG. 12) move in the + direction (the right in FIG. 12) as compared with that shown in FIG. 7.

Thus, the widthwise central positions WM of the half-width webs 12A move in the + direction (to the right in FIG. 12), as indicated by the chain double-dashed line in FIG. 12, as compared with the state in FIG. 7, so that they deviate from the widthwise processing central positions MM of the folding processing devices F.

In this case, information about broadsheet format printing, four-page printing, and a 56-inch paper size (1,422 mm paper width) is transmitted from an operation control unit (not shown) to the position-adjustment control unit 43.

In the position-adjustment control unit 43, the PLC CPU 75 selects the widthwise positions B of the former boards 23 from the information stored in the memory board 73 on the basis of this information.

The PLC CPU 75 calculates the moving directions and moving distances of the former boards 23 on the basis of the difference between the selected widthwise positions B of the former boards 23 and the present positions of the former boards 23 input via the analog input board 77.

The PLC CPU 75 rotationally drives the electric motor 49 via the I/O output board 79 on the basis of the calculated moving directions and moving distances of the former boards 23 to move the former boards 23, in this case, in the − direction.

This makes the widthwise central positions WM of the half-width webs 12A from the former boards 23 and the widthwise processing central positions MM of the folding processing devices F match.

Since the other operations are the same as those described with reference to FIG. 7, duplicated descriptions thereof will be omitted there.

In this way, the position-adjustment control unit 43 changes the predetermined widthwise central positions WM in accordance with the width of the webs 11B processed by the former boards 23, so that the widthwise central positions WM of the half-width webs 12A and 12B and the widthwise processing central positions MM of the folding processing devices F can be matched even in a print job for a web 11A having a different width.

Although this embodiment uses the forms of the half-width webs 12A and 12B (i.e., folded-in-two or two layers), the number of overlaying layers of the webs 11B, and the width of the web 11A as parameters for adjusting the positions of the former boards 23, they are not limited thereto.

For example, only the forms of the half-width webs 12A and 12B offer sufficient advantages. These parameters may be omitted as long as the paper width of the web 11A is constant.

Furthermore, the thickness of the web 11A, the circumferential speed of the nipping collars (nipping rollers) 63 or the folding cylinders 33 that constitute the folding processing devices F may be added as necessary.

The thickness of the web 11A allows correction similar to the number of overlaying layers of the webs 11B, although its influence is much smaller than it.

By adjusting the circumferential speed of the nipping collars (nipping rollers) 63 or the folding cylinders 33, the tensions of the half-width webs 12A and 12B from the former boards 23 to the first nipping roller devices 27, from the first nipping roller devices 27 to the second nipping roller devices 31, or from the second nipping roller devices to the folding cylinders 33 can be adjusted, so that the half-width webs 12A and 12B therebetween can be extended or contracted. When the half-width webs 12A and 12B extend or contract, the widths of the half-width webs 12A and 12B decrease or increase. The decrease and increase of the widths change on both sides of the half-width webs 12A and 12B depending on the state of the half-width webs 12A and 12B, so that the widthwise positions WM of the half-width webs 12A and 12B can be changed.

This allows the widthwise central positions WM of the half-width webs 12A and 12B and the widthwise processing central positions MM of the folding processing devices F to be matched with even higher accuracy.

Although this embodiment is configured to make the widthwise central positions WM of the half-width webs 12A and 12B and the widthwise processing central positions MM of the folding processing devices F match by moving the former boards 23, it may be achieved by moving the folding processing device F or by moving both the former boards 23 and the folding processing devices F.

Furthermore, although this embodiment has been described in terms of its an application to the web offset press 1 for printing newspaper, the present invention is not limited to newspaper printing; it may of course be applied to general web offset presses.

Furthermore, although this embodiment is configured such that the position-adjustment control unit 43 has the function of selecting and calculating the amount of control, this function may be separated; for example, it may be provided in a production management system or a component for controlling the operation of the web offset press 1.

### Second Embodiment

Next, a second embodiment of the present invention will be described with reference to FIGS. 13 and 14.

This embodiment is similar to the first embodiment in basic structure but differs in the installed number of former boards and the position-adjustment control unit 43. Thus, in this embodiment, only the differences will be described, and duplicated description of the other parts will be omitted.

The same components as in the first embodiment are given the same reference numerals, and detailed descriptions thereof will be omitted.

FIG. 13 is a side view showing the upper part of a folding device.

This embodiment has three sets of the former boards 23 in the first embodiment. For the reference numerals of the added two sets, one is given one hundred and the other is given two hundred, and those having the same last two digits denote the same components.

Web running routes 91, 191, and 291, through which the half-width webs 12A formed by the former boards 23, 123, and 223 run, are formed from the former boards 23, 123, and 223 to the first nipping roller devices 27, respectively. The web running routes 191 and 291 are formed so as to pass outside with guide rollers 193 and 293, respectively.

Detection devices (sensor units) 95, 195, and 295 for detecting the central positions in the widthwise direction B or the widthwise end positions of the half-width webs 12A are provided at positions of the web running routes 91, 191, and 291 close to the first nipping roller devices 27.

The detection devices 95, 195, and 295 have sensors 97, 197, and 297 for detecting the presence or absence of the half-width webs 12A and potentiometers 99, 199, and 299 for detecting the positions of the sensors 97, 197, and 297, respectively.

The I/O output board 79 of the position-adjustment control unit 43 is configured to receive the detection signals from the sensors 97, 197, and 297.

The analog input board 77 is configured to acquire voltage values from the potentiometers 99, 199, and 299.

The operation of the web offset press 1 with such a configuration according to this embodiment will be described.

Since the basic operation is similar to that of the first embodiment, duplicated descriptions thereof will be omitted, and the operation of the position-adjustment control unit 43 will be described.

As in the first embodiment, the position-adjustment control unit 43 sets the individual former boards 23, 123, and 223 in predetermined widthwise positions before printing. When the printing operation is executed, the half-width webs 12A formed with the former boards 23, 123, and 223, pass along the web running routes 91, 191, and 291, are overlaid in front of (at the upstream side of) the first nipping roller devices 27, and are introduced to the first nipping roller devices 27.

In this way, the widthwise central positions of the half-width webs 12A and the widthwise processing central positions of the folding processing devices can be matched at all times at the former boards 23, 123, and 223, so that the widthwise central positions of the half-width webs 12A can be aligned at a fixed position.

Accordingly, this allows them to be aligned when introducing them in layers to the first nipping roller devices 27, thus preventing the possibility of causing product quality problems in the signatures 71.

At that time, the sensors 97, 197, and 297 reciprocate in the widthwise direction B (in the direction perpendicular to the plane of the drawing in FIG. 13) to detect the presence or absence of the half-width webs 12A. The sensors 97, 197, and 297 send detection signals thereof to the I/O output board 79.

At the same time, the potentiometers 99, 199, and 299 detect the positions of the sensors 97, 197, and 297 in the widthwise direction B and send them to the analog input board

The position-adjustment control unit 43 calculates the widthwise central positions of the half-width webs 12A on the basis of these detection signals. If the calculations differ from predetermined widthwise positions, it moves the widthwise positions B of the former boards 23, 123, and 223 in accordance with deviations therebetween; i.e., it finely adjusts them to the optimum positions for actual operation.

In this way, in the position-adjustment control unit 43, the detection devices 95, 195, and 295 detect the widthwise central positions of the half-width webs 12A passing therethrough, and the position-adjustment control unit 43 moves the former boards 23, 123, and 223 on the basis of detection values therefrom, so that, even if the widthwise positions of the half-width webs 12A move between the former boards 23, 123, and 223 and the positions of the detection devices 95, 195, and 295, they can be corrected.

In other words, it can move the former boards 23, 123, and 223, making allowance for the widthwise movement of the half-width webs 12A between the former boards 23, 123, and 223 and the positions of the detection devices 95, 195, and 295.

That is, during the printing operation, the positions of the former boards 23, 123, and 223 can be adjusted in accordance with the actual widthwise positions of the half-width webs 12A introduced to the first nipping roller devices 27.

Since the detection devices 95, 195, and 295 are provided close to the first nipping roller devices 27, the accuracy of adjustment can be further improved.

Accordingly, this allows the widthwise central positions of the half-width webs 12A and the widthwise processing central positions of the folding processing devices to be further matched, thus reducing the possibility of causing product quality problems in the signatures 71.

Furthermore, the accuracy of initial settings of the predetermined widthwise positions can be improved gradually by updating the predetermined widthwise positions using data on the widthwise positions of the adjusted former boards.

The present invention is not limited to the above-described embodiments; modifications can be made as appropriate without departing from the spirit of the present invention.

1. A web offset press comprising:
a former board;
a folding processing device that processes a half-width web that is folded in two or is overlaid in two layers by the former board into a signature; and
a position-adjustment control device that adjusts the position of the former board and/or the folding processing device in the widthwise direction of the half-width web so as to match the widthwise central position of the half-width web and the widthwise processing central position of the folding processing device;
wherein the position-adjustment control device stores a predetermined widthwise position of the former board and/or the folding processing device according to the form of the half-width web and moves the former board and/or the folding processing device to the predetermined widthwise position.

2. The web offset press according to claim 1, wherein the position-adjustment control device updates the predetermined widthwise position using data on the widthwise position of the former board and/or the folding processing device that are/is finely adjusted after initial setting.

3. The web offset press according to claim 1, wherein the position-adjustment control device changes the predetermined widthwise position in accordance with the number of folded webs processed by the former board.

4. The web offset press according to claim 1, wherein the position-adjustment control device changes the predetermined widthwise position in accordance with the width of a web processed by the former board.

5. The web offset press according to claim 1, wherein the position-adjustment control device changes the predetermined widthwise position in accordance with the thickness of a web processed by the former board.

6. The web offset press according to claim 1, wherein the position-adjustment control device changes the predetermined widthwise position in accordance with the circumferential speed of nipping rollers or a folding cylinder, which are the folding processing device.

7. The web offset press according to claim 1, wherein
a plurality of the former boards are provided; and
the position-adjustment control device adjusts the positions of the former boards in the widthwise direction of the half-width web.

8. The web offset press according to claim 1, further comprising:
a sensor unit for sensing the central position of the half-width web in a web running route along which the half-width web passes from the former board to the folding processing device,
wherein the position-adjustment control device moves the former board and/or the folding processing device on the basis of the detection value from the sensor unit.
